(19) United States
(12) Patent Application Publication
(10) Pub. No.: US 2010/0271231 A1
(43) Pub. Date: Oct. 28, 2010

(54) Two-Sided Handheld Remote Control

(76) Inventor: Mark Gottlieb, Fairfax Station, VA (US)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 12/428,970

(22) Filed: Apr. 23, 2009

(51) Int. Cl. G05B 19/02

(52) U.S. Cl. 340/825.22

(57) ABSTRACT

A two-sided remote control includes a logic device for controlling and/or communicating with a transmitter and a button detector which detects the statuses of two sets of buttons on opposite sides of the two-sided remote control. Both sets of buttons are in the same locations on their respective faces such that one set of buttons is always oriented upwards and with a set of buttons in locations expected by a user. The two-sided remote control may further include an orientation detector which can be used to cause buttons presses on the buttons of the downward oriented face to be ignored.

### FIELD OF INVENTION

The present invention is directed to a two-sided handheld remote control as may be used in an automotive key fob or in any application where the surface area of the two major surfaces of a remote control are substantially larger than the sides of the remote control.

### DISCUSSION OF THE BACKGROUND

Keyless entry transmitters for automotive type applications (as well as home applications) have the buttons on one face of the key fob. While often (e.g., on sufficiently warm and sunny days) this is acceptable, such a configuration is actually awkward when it is dark and/or when one is wearing gloves. The configuration is awkward because it is hard for the user to detect the ‘up orientation’ of the key fob when approaching one's car in the dark. Often most of the buttons are somewhat flush with the surface of the fob, and with gloves it is almost impossible to tell which side is which. In the event (50% of the time) that the key fob ends up in the up-side-down position (facing away from the user's thumb which is actually pressing on the backside of the fob), the user must flip the key fob over to the up orientation after realizing that the buttons are on the opposite side.

### BRIEF DESCRIPTION OF THE DRAWINGS

The following description, given with respect to the attached drawings, may be better understood with reference to the non-limiting examples of the drawings, wherein:

FIG. 1A and 1B are top perspective views of sides A and B of the same key fob according to one embodiment of the present invention;

FIG. 2 is a block diagram on an exemplary implementation of the internal circuitry of a remote control according to the present invention; and

FIG. 3A and 3B are top perspective views of sides A and B of the same key fob according to one embodiment of the present invention.

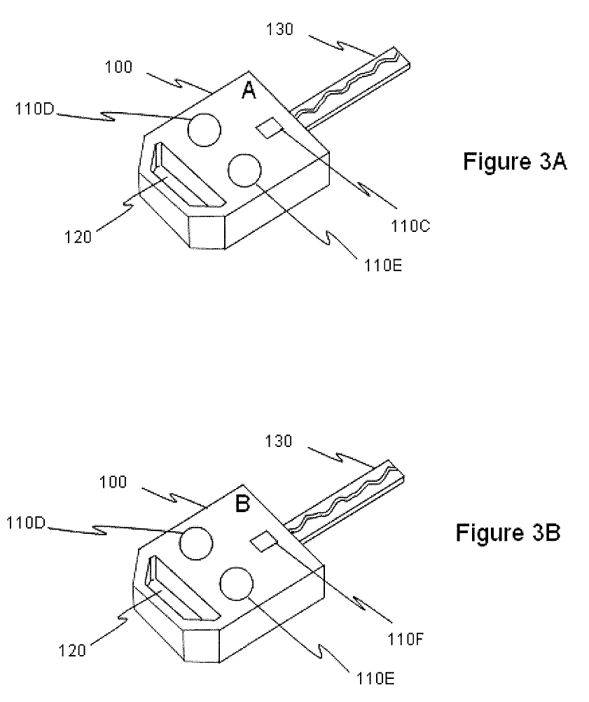

### DISCUSSION OF THE PREFERRED EMBODIMENTS

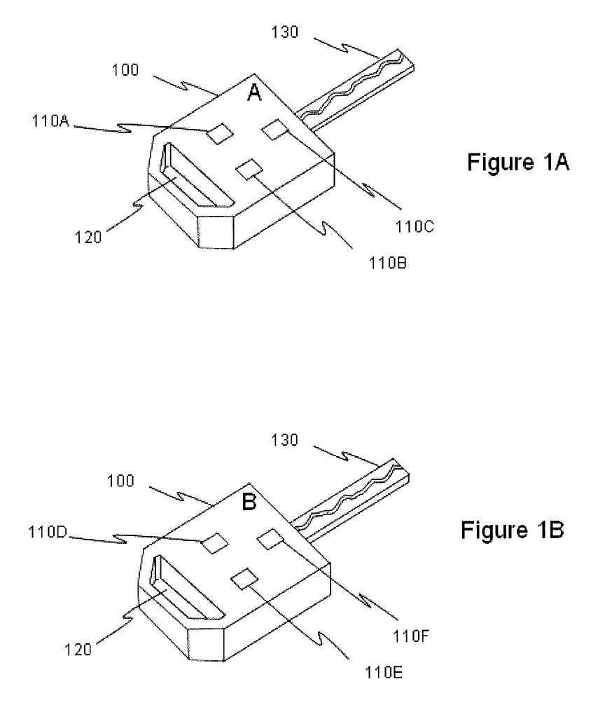

Turning to FIG. 1A, a first side (labeled “A”) of a remote control 100 (e.g., a key fob) is illustrated as including a first set of three buttons (110A, 110B and 110C), a hole 120 such as one would use to place a key ring through, and a physical key 130 (e.g., as one would use to physically open a door or start a car). FIG. 1B illustrates the second side (labeled “B”) of the remote control 100 of FIG. 1A, and on the second side is a second set of three buttons (110D, 110E and 110F) along with the hole 120 such as one would use to place a key ring through. The first set of buttons (110A, 110B and 110C) and the second set of buttons (110D, 110E and 110F) have the same functions at the same positions. For example, buttons 110A and 110D may both have a “car unlock” function, whereas buttons 110B and 110E may both have a “car lock” function. Similarly, buttons 110C and 110F may both have a “trunk release” function. The surface areas of the first and second sides are shown as being substantially greater than the surface area of the sides.

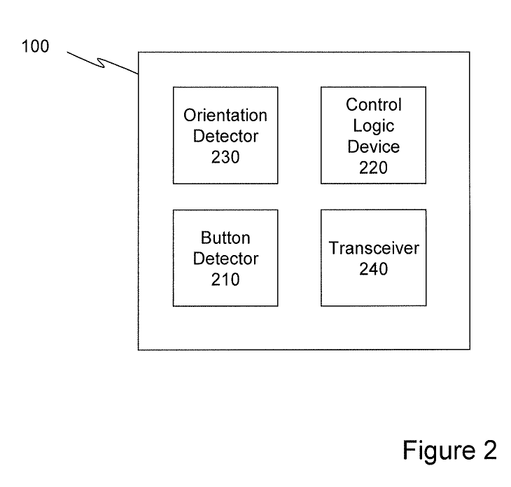

As shown in FIG. 2, the remote control includes a button detector 210 (e.g., a mechanical switch, conductive rubber, capacitance, optical, etc., either alone or with one or more pull-up or pull-down resistors or optical detectors for sensing if and/or how much the buttons are pressed) which is connected to at least one logic input of a control logic device 220 (such as a programmed processor or other special-purpose hardware). The button detector 210 indicates to the control logic device 220 the statuses of the buttons (e,g., 110A-110F). Such statuses may be instantaneous statuses (i.e., the current status of the buttons) or may be latched statuses (e.g., a change in a button's status occurred since a last time the latch was read or reset). The button detector 210 may optionally further include “debouncing” circuitry to “debounce” the switches. The control logic device 220 may optionally further provide “debouncing” circuitry to “debounce” the switches.

As also shown in FIG. 2, the remote control 100 further includes an orientation detector 230 which detects which side (A or B) is face up (or alternatively, which side is face down). Orientation detectors may include, but are not limited to, a mercury switch, a roller ball sensor, and a cantilever type sensor which bends one way or the other depending on orientation. A capacitance sensor could further be used as an orientation detector by detecting the greater capacitance level of the bottom side compared to the top side when the key fob is held in a hand as the bulk of the mass of the hand is against the bottom of the key fob.

By utilizing the orientation detected by the orientation detector 230, the control logic device 220 can ignore the ‘down side’ set of buttons in favor of the ‘up side’ set of buttons. For example, if the first set up buttons 110A-110C were face up, then any accidental depression of any of the buttons of the second set of buttons 110D-110F would be ignored.

As also shown in FIG. 2, the remote control 100 further includes a transmitter 240 for transmitting, optionally with a receiver for receiving information between the remote control 100 and the controlled device (e.g., car alarm/remote start system, television, cable box), or a transceiver for transmitting and receiving. The remote control 100 may be any kind of remote control (e.g., TV and Audio remote controls, ceiling fan remote controls, garage remote controls, light remote controls and toy or gaming controller remote controls). The transceiver 240 may transmit information using any one or a combination of known methods (e.g., radio-frequency (RF), infrared (IR), Ultrasonic, or acoustic). Furthermore, any transmission protocol could be used. In one embodiment, an automotive key fob is implemented as a low power RF system in the 300 to 900 Mhz range with a variety of encoding algorithms sending short data bits representing the ID code of the remote control and the button being pushed. These ID codes can be fixed or of a ‘rolling code” type. In one embodiment of the present invention, the statuses of all the buttons are transmitted with each message. In an alternate embodiment, only the statuses of the buttons that have changed are transmitted. In yet a further embodiment, only the meaning of a change in the status of one or more buttons is transmitted with each message (e.g., “car unlock depressed”, “car unlock released”, “open trunk”).

In an embodiment where communications signals are received back from the controlled device, the communications signals could provide information as to the state of the controlled device and display this visually or audibly (e.g., an audio- and/or visual-indication that the door of the car is locked or the alarm is set).

In an embodiment using a capacitance sensor for an orientation detector, the control logic 220 could be configured to disable the buttons of the remote control until the orientation detector 230 senses the capacitance of a hand around the key fob. This would greatly reduce the possibility of accidental pushing of a button in a pocket or purse.

In an alternate embodiment, separate physical push buttons on each face could instead be replaced by or supplemented with touch sensitive buttons, a touch sensitive screen or at least one other visual indicator (e.g., an LED). In such an embodiment, the same type of visual indicators, touch sensitive buttons or touch sensitive screen(s) used on the first face would be used on the second face as well.

While certain configurations of structures have been illustrated for the purposes of presenting the basic structures of the present invention, one of ordinary skill in the art will appreciate that other variations are possible which would still fall within the scope of the appended claims.

We claim:

1. A two-sided remote control, comprising:
a first set of buttons on a first face of the remote control;
a second set of buttons on a second face of the remote control, wherein a first button of the first set of buttons on the first face of the remote control has a same function as a second button of the second set of buttons on the second face of the remote control, and wherein the first and second buttons are at a same location on their corresponding faces;
a button detector for detecting statuses of the first and second buttons;
a transmitter for transmitting information relating to at least one of the statuses of the first and second buttons; and
a control logic device for receiving the at least one of the statuses of the first and second buttons and providing the information relating to the at least one of the statuses of the first and second buttons to the transmitter.

2. The two-sided remote control as claimed in claim 1, further comprising an orientation detector for detecting whether an orientation of the remote control corresponds to the first face being face up or the second face being face up.

3. The two-sided remote control as claimed in claim 2, wherein the orientation detector comprises a mercury switch.

4. The two-sided remote control as claimed in claim 2, wherein the orientation detector comprises a roller ball sensor.

5. The two-sided remote control as claimed in claim 2, wherein the orientation detector comprises a cantilever type sensor.

6. The two-sided remote control as claimed in claim 2, wherein the orientation detector comprises a capacitance sensor.

7. The two-sided remote control as claimed in claim 1, wherein the transmitter comprises a radio-frequency (RF) transmitter.

8. The two-sided remote control as claimed in claim 1, wherein the transmitter comprises an infrared transmitter.

9. The two-sided remote control as claimed in claim 1, wherein the transmitter comprises an ultrasonic transmitter.

10. The two-sided remote control as claimed in claim 1, wherein the transmitter comprises an acoustic transmitter.

11. The two-sided remote control as claimed in claim 1, further comprising a capacitance sensor for detecting whether the remote control is in a hand of a user and for disabling the button detector if the capacitance sensor does not detect that the remote control is in the hand of the user.

12. The two-sided remote control as claimed in claim 1, wherein the first and second sets of buttons are both sets of push buttons.

13. The two-sided remote control as claimed in claim 1, wherein the first and second sets of buttons are both sets of touch sensitive buttons.

14. The two-sided remote control as claimed in claim 1, wherein the first and second sets of buttons are both implemented as touch screens.

15. The two-sided remote control as claimed in claim 1, wherein the button detector for detecting statuses of the first and second buttons detects the status of the first button when the first face is face up and detects the status of the second button when the second face is face up.
